(19) United States
(12) Patent Application Publication
(10) Pub. No.: US 2016/0347404 A1
(43) Pub. Date: Dec. 1, 2016

(54) Transmission System for a Bicycle

(71) Applicants: Hubert Chen, Taichung City (TW); Yung-Yuan Liao, Taichung City (TW)

(72) Inventors: Hubert Chen, Taichung City (TW); Yung-Yuan Liao, Taichung City (TW)

(21) Appl. No.: 14/955,796

(22) Filed: Dec. 1, 2015

(30) Foreign Application Priority Data
May 29, 2015 (TW) 104208518

(51) Int. Cl. B62M 1/36

(52) U.S. Cl. CPC B62M 1/36

(57) ABSTRACT

A transmission system includes a hub unit and a crankshaft for being respectively mounted to seat stays and a bottom bracket of a bicycle, a transmission unit and an engaging unit. The transmission unit includes a driving sprocket sleeved on the crankshaft, at least one driven sprocket mounted to the hub unit, and a chain trained on the driving and driven sprockets. The engaging unit includes first and second ratchet members sleeved co-rotatably on the crankshaft, and a resilient element for biasing the first ratchet member toward the second ratchet member. The first ratchet member is slidable relative to the crankshaft and has first ratchet teeth. The second ratchet member is co-rotatable with the driving sprocket and has second ratchet teeth.

### CROSS-REFERENCE TO RELATED APPLICATION

This application claims priority of Taiwanese Application No. 104208518, filed on May 29, 2015.

### FIELD

The disclosure relates to a transmission system, more particularly to a transmission system for a bicycle.

### BACKGROUND

Taiwanese Patent No. 1291428 discloses a pedal-operated crank driving apparatus for a bicycle. The pedal-operated crank driving apparatus includes a driving unit, a driven unit, and a plurality of pawl units. The driving unit includes a shaft assembly having a ratchet base and two crank arms respectively connected to two opposite ends of the shaft assembly. The driven unit includes a first bearing sleeved on the shaft assembly, and a pawl base rotatably sleeved on the first bearing. The pawl units are surrounded by and connected to the pawl base. Each of the pawl units has a pawl engageable with the ratchet base, and an elastic member for providing an elastic force to the pawl. However, the configuration of multiple pawl units results in a relatively large volume of the device, a relatively complicated assembling process, and a relatively high manufacturing cost.

### SUMMARY

Therefore, the object of the disclosure is to provide a transmission system for a bicycle that has a simple structure and that is easy to be assembled.

Accordingly, a transmission system of the present disclosure is adapted for being installed in a bicycle, and includes a hub unit, a drive unit, a transmission unit and an engaging unit. The hub unit is mounted to seat stays of the bicycle, and includes a hub shell that is adapted to be rotatable relative to the seat stays. The drive unit includes a crankshaft that is adapted to be connected to a bottom bracket of the bicycle, and that extends along and is rotatable about a crankshaft axis. The crankshaft has a first section, a second section, a third section and a limit section arranged in sequential order along the crankshaft axis. The transmission unit includes a driving sprocket that is sleeved on the first section of the crankshaft, at least one driven sprocket that is mounted to the hub shell, and a chain that is trained on the driving sprocket and the driven sprocket. The engaging unit includes a first ratchet member, a second ratchet member, and a resilient element. The first ratchet member is sleeved co-rotatably on the second section of the crankshaft, is slidable relative to the second section of the crankshaft along the crankshaft axis, and has an end surface formed with a plurality of first ratchet teeth. The second ratchet member is sleeved on the second section of said crankshaft, is co-rotatable with the driving sprocket, and has an end face formed with a plurality of second ratchet teeth that face the first ratchet teeth. The resilient element is sleeved on the third section of the crankshaft, and has one end resiliently biasing the limit section of the crankshaft, and an opposite end resiliently biasing the first ratchet member toward the second ratchet member. The driving sprocket is co-rotatable with the crankshaft via engagement between the first ratchet teeth and the second ratchet teeth when the crankshaft is rotated in a rotational direction. The first ratchet teeth are disengaged from the second ratchet teeth to push the first ratchet member along the crankshaft axis away from the second ratchet member against a resilient force of the resilient element when the driving sprocket is rotated in the rotational direction relative to the crankshaft.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary sectional view of a drive unit, a part of a transmission unit and an engaging unit of an embodiment of a transmission system according to the disclosure;

FIG. 2 is a fragmentary sectional view of a hub unit and another part of the transmission unit of the embodiment;

FIG. 3 is a fragmentary exploded perspective view of the drive unit, the part of the transmission unit and the engaging unit of the embodiment;

FIG. 4 is an exploded perspective view of the engaging unit and a crankshaft of the drive unit of the embodiment;

FIG. 5 is an enlarged fragmentary sectional view of the drive unit, the part of the transmission unit and the engaging unit of the embodiment, illustrating a first ratchet teeth engaging second ratchet teeth; and

FIG. 6 is a view similar to FIG. 5, but illustrating the first ratchet teeth being disengaged from the second ratchet teeth.

### DETAILED DESCRIPTION

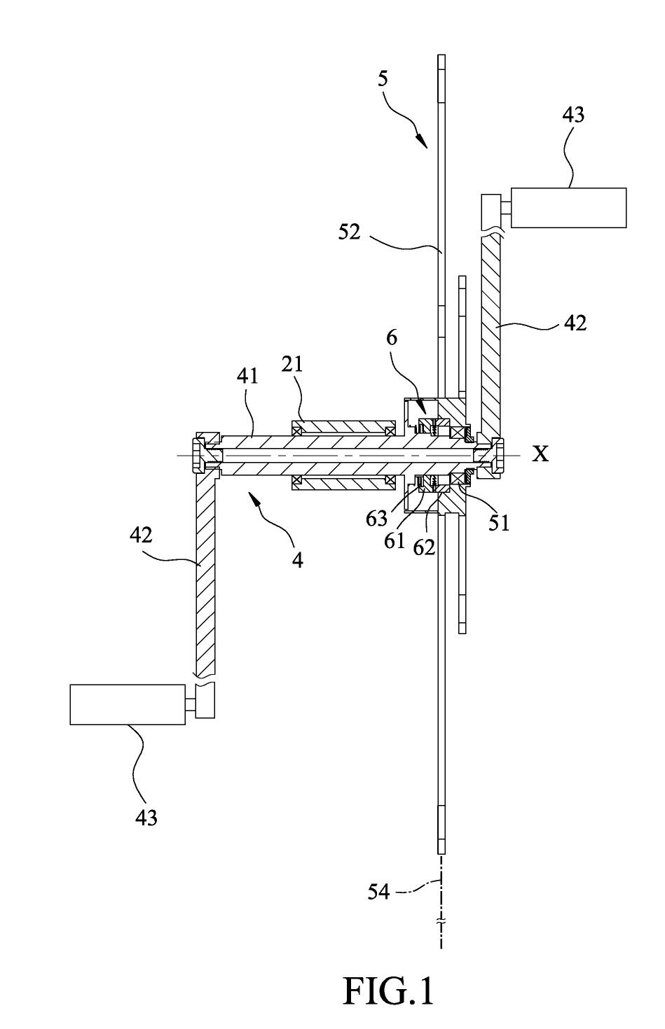

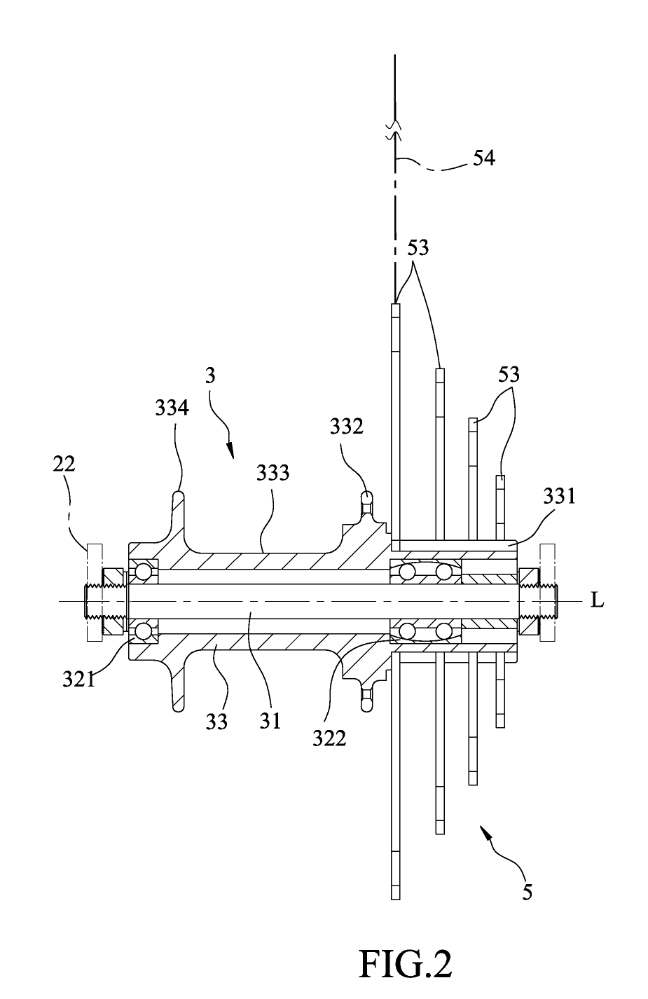

As shown in FIGS. 1 and 2, the embodiment of a transmission system according to the present disclosure is adapted for being installed in a bicycle, and includes a hub unit 3, a drive unit 4, a transmission unit 5 and an engaging unit 6.

Referring to FIG. 2, the hub unit 3 includes an axle 31 adapted to be mounted to seat stays 22 of the bicycle and extending along an axle axis (L), a first bearing 321 and a second bearing 322 sleeved on the axle 31, and a hub shell 33 sleeved on the axle 31 with the first bearing 321 and the second bearing 322 being interposed therebetween and adapted to be rotatable relative to the seat stays 22 about the axle axis (L). The hub shell 33 is formed as one piece, and has a sprocket-mounting portion 331, a first spoke-mounting portion 332, a tubular portion 333, and a second spoke-mounting portion 334 arranged in sequential order along the axle axis (L). In this embodiment, the first bearing 321 is a ball bearing and is at a position adjacent to the second spoke-mounting portion 334 of the hub shell 33, and the second bearing 322 is a double row self-aligning ball bearing and is at a position adjacent to the sprocket-mounting portion 331 of the hub shell 33. The outer ring of the second bearing 322 has a concave annular inner surface serving as a raceway for balls of the double row self-aligning ball bearing.

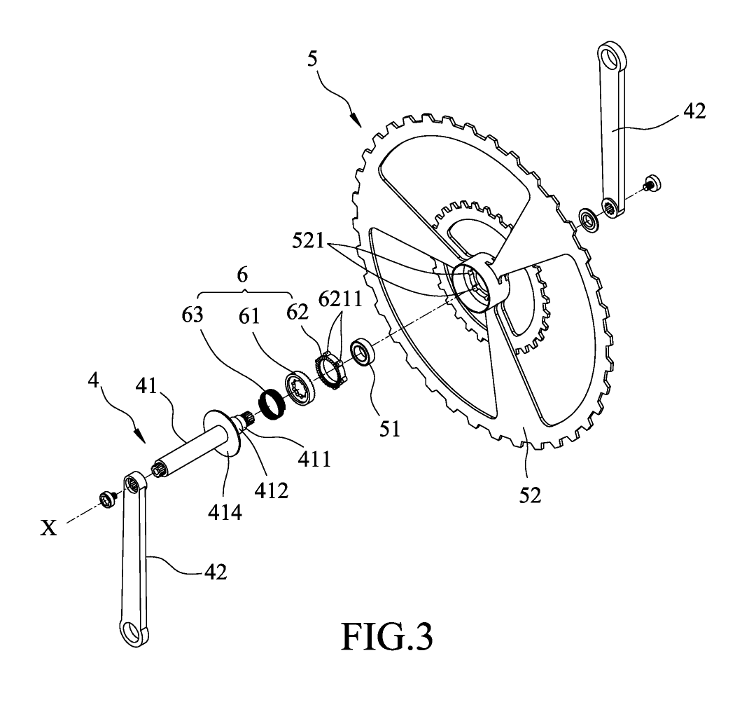

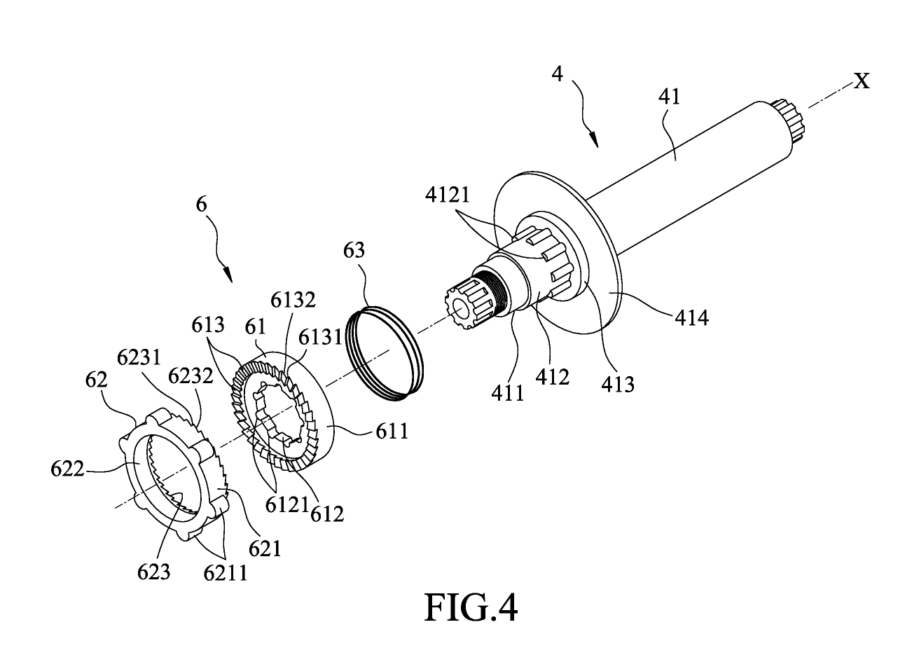

Referring back to FIGS. 1, and further referring to FIGS. 3 and 4, the drive unit 4 includes a crankshaft 41 adapted to be connected to a bottom bracket 21 of the bicycle, a pair of crank arms 42 mounted respectively at opposite ends of the crankshaft 41, and a pair of pedals 43 respectively mounted on the crank arms 42.

The crankshaft 41 extends along and is rotatable about a crankshaft axis (X), and has a first section 411, a second section 412, a third section 413 and a limit section 414 arranged in sequential order along the crankshaft axis (X). The second section 412 of the crankshaft 41 has an outer surface formed with a plurality of angularly spaced-apart slide blocks 4121.

As shown in FIGS. 1 to 3, the transmission unit 5 includes a bearing 51 sleeved on the first section 411 of the crankshaft 41, and a driving sprocket 52 sleeved on the first section 411 of the crankshaft 41. The bearing 51 is interposed between the first section 411 of the crankshaft 41 and the driving sprocket 52. In this embodiment, the transmission unit 5 further includes a plurality of driven sprockets 53 mounted on the sprocket-mounting portion 331 of the hub shell 33, and a chain 54 trained on the driving sprocket 52 and the driven sprocket 53. The driving sprocket 52 has a plurality of angularly spaced-apart coupling grooves 521 (see FIG. 3) surrounding the crankshaft axis (X). Generally, a bicycle includes one driving sprocket 52 and one driven sprocket 53 for transmission, or a plurality of the driving sprockets 52 and a plurality of the driven sprockets 53 for additionally providing multiple gear ratios to a user. Since this technique is well known in the art, detailed description thereof is omitted for the sake of brevity.

As shown in FIGS. 3 to 5, the engaging unit 6 includes a first ratchet member 61, a second ratchet member 62, and a resilient element 63.

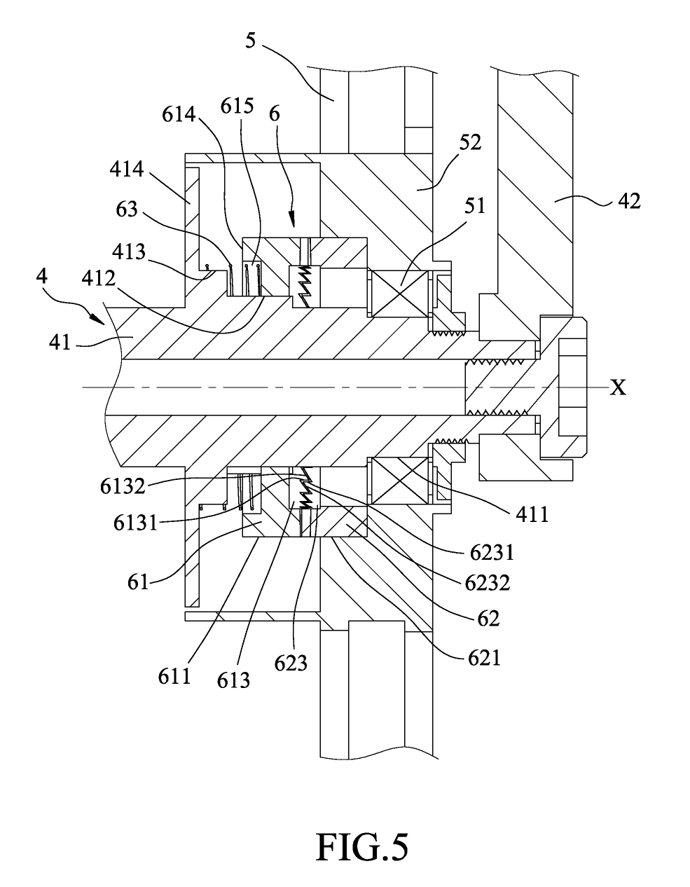

The first ratchet member 61 has an outer surrounding surface 611, an inner surrounding surface 612 surrounded by the outer surrounding surface 611, a plurality of angularly spaced-apart slide grooves 6121 formed in the inner surrounding surface 612 and respectively engageable with the slide blocks 4121, an end surface interconnecting the outer and inner surrounding surfaces 611, 612 and formed with a plurality of first ratchet teeth 613 that are continually arranged, a groove-defining surface 614 (see FIG. 5) opposite to the first ratchet teeth 613 along the crankshaft axis (X), and a retaining groove 615 formed in the groove-defining surface 614. The first ratchet member 61 is sleeved on the second section 412 of the crankshaft 41, and is co-rotatable with and slidable relative to the second section 412 of the crankshaft 41 via the engagement between the slide grooves 6121 and the slide blocks 4121.

Each of the first ratchet teeth 613 has a plurality of abutment surfaces 6131 that are parallel to the crankshaft axis (X), and a plurality of parallel slide surfaces 6132 that are inclined relative to the abutment surfaces 6131 and that are arranged alternately with the abutment surfaces 6131. Each of the slide surfaces 6132 and an adjacent one of the abutment surfaces 6131 cooperatively define an acute angle therebetween.

The second ratchet member 62 has an outer surrounding face 621, an inner surrounding face 622 surrounded by the outer surrounding face 621, a plurality of angularly spaced-apart coupling blocks 6211 formed on the outer surrounding face 621, and an end face interconnecting the outer and inner surrounding faces 621, 622 and formed with a plurality of second ratchet teeth 623 that face the first ratchet teeth 613. The second ratchet member 62 is sleeved on the second section 412 of the crankshaft 41, and is co-rotatable with the driving sprocket 52 via the engagement between the coupling grooves 521 and the coupling blocks 6211.

Each of the second ratchet teeth 623 has a plurality of abutment faces 6231 that are parallel to the crankshaft axis (X), and a plurality of parallel slide faces 6232 that are inclined relative to and are arranged alternately with the abutment faces 6231. The shape of the second ratchet teeth 623 is designed to be corresponding to that of the first ratchet teeth 613 so as to perform proper ratchet engagements.

The resilient element 63 is sleeved on the third section 413 of the crankshaft 41, and has one end resiliently biasing the limit section 414 of the crankshaft 41, and an opposite end inserted into the retaining groove 615 of the first ratchet member 61 (i.e., the retaining groove 615 retains the opposite end of the resilient element 63) and resiliently biasing the first ratchet member 61 toward the second ratchet member 62.

Referring to FIG. 5, when the crankshaft 41 of the drive unit 4 is rotated in a rotational direction, the first ratchet member 61 is rotated together with the crankshaft 41 and is pushed by the resilient element 63 to the second ratchet member 61 such that the first ratchet teeth 613 engage co-rotatably the second ratchet teeth 623. Specifically, the abutment surfaces 6131 of the first ratchet teeth 613 abut respectively against the abutment faces 6231 of the second ratchet member 62 to co-rotate the driving sprocket 52 with the crankshaft 41. The driven sprocket 53 is then driven to rotate together with the driving sprocket 52 via the chain 54.

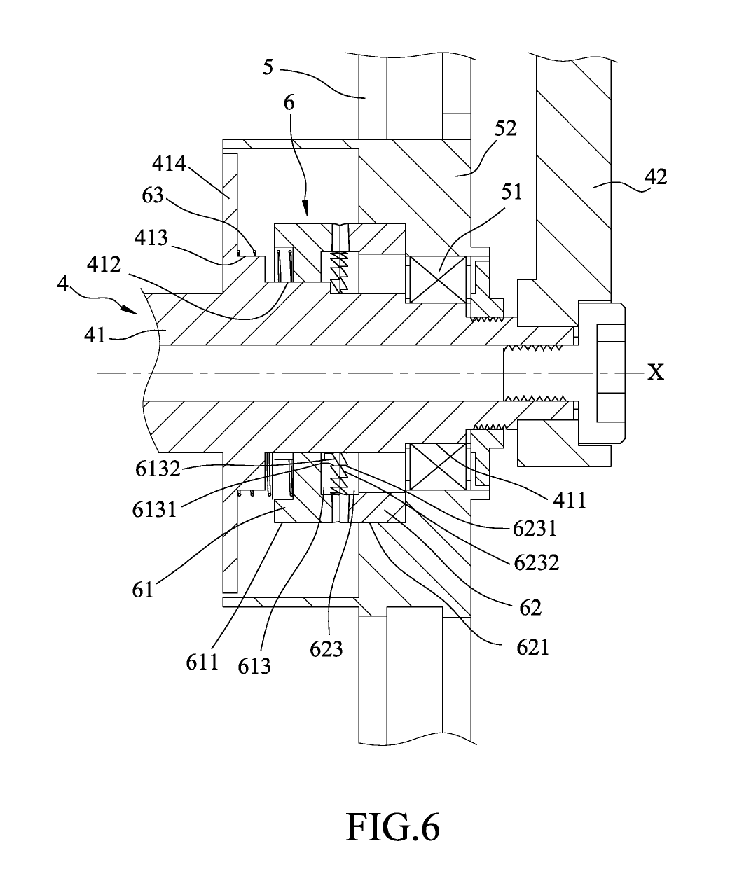

Referring to FIG. 6, the first ratchet teeth 613 are disengaged from the second ratchet teeth 623 via slide movement of the parallel slide faces 6232 of the second ratchet teeth 623 relative to the parallel slide surfaces 6132 of the first ratchet teeth 613 when the second ratchet member 62 is rotated in the rotational direction relative to the first ratchet member 61, such that the first ratchet member 61 is pushed along the crankshaft axis (X) away from the second ratchet member 62 against the a resilient force of the resilient element 63. At this time, the first ratchet member 61 is not driven by the second ratchet member 62.

In general use, to propel the bicycle, the crank arms 42 are driven to be rotated in the rotation direction when the pedals 43 are stepped on by the user, and the crankshaft 41 is then driven to rotate in the rotational direction. As a result, the driving sprocket 52 is rotated in the rotational direction. When the pedals 43 are not stepped on, the bicycle is driven by inertia or gravity to move continually forward, the transmission unit 5 and the second ratchet member 62 continues to be rotated in the rotation direction, and the first and the second ratchet members 61, 62 are separated from each other so that the first ratchet member 61 and the drive unit 4 are not driven. At this moment, the driving sprocket 52 remains connected with the driven sprocket 53 such that the user can change gears without pedaling the bicycle.

As abovementioned, the transmission system of the disclosure has the following advantages:

1. The engaging unit 6 has a simple structure, and can be easily assembled with the crankshaft 41 and the driving sprocket 52, which leads to a relatively low manufacturing cost.

2. With the configuration of the multiple first ratchet teeth 613 engaging the multiple second ratchet teeth 623, the first ratchet member 61 can engage firmly the second ratchet member 62.

3. When the first ratchet member 61 is disengaged from the second ratchet member 62, the distance between the first ratchet member 61 and the second ratchet member 62 is small, so that when the drive unit 4 is once again driven to rotate the first ratchet member 61, the second ratchet member 62 can be driven to rotate in short time to then drive rotation of the transmission unit 5.

4. The hub shell 33 is formed as one piece with aluminum alloy material and is easy to be manufactured, thereby further decreasing the manufacturing cost.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A transmission system adapted for being installed in a bicycle, said transmission system comprising:
a hub unit mounted to seat stays of the bicycle, and including a hub shell that is adapted to be rotatable relative to the seat stays;
a drive unit including a crankshaft that is adapted to be connected to a bottom bracket of the bicycle, and that extends along and is rotatable about a crankshaft axis, said crankshaft having a first section, a second section, a third section and a limit section arranged in sequential order along the crankshaft axis;
a transmission unit including a driving sprocket that is sleeved on said first section of said crankshaft, at least one driven sprocket that is mounted to said hub shell, and a chain that is trained on said driving sprocket and said driven sprocket; and
an engaging unit including
a first ratchet member that is sleeved co-rotatably on said second section of said crankshaft, that is slidable relative to said second section of said crankshaft along the crankshaft axis, and that has an end surface formed with a plurality of first ratchet teeth,
a second ratchet member that is sleeved on said second section of said crankshaft, that is co-rotatable with said driving sprocket, and that has an end face formed with a plurality of second ratchet teeth that face said first ratchet teeth, and
a resilient element that is sleeved on said third section of said crankshaft, and that has one end resiliently biasing said limit section of said crankshaft, and an opposite end resiliently biasing said first ratchet member toward said second ratchet member, said driving sprocket being co-rotatable with said crankshaft via engagement between said first ratchet teeth and said second ratchet teeth when said crankshaft is rotated in a rotational direction, said first ratchet teeth being disengaged from said second ratchet teeth to push said first ratchet member along the crankshaft axis away from said second ratchet member against a resilient force of said resilient element when said driving sprocket is rotated in the rotational direction relative to said crankshaft.

2. The transmission system as claimed in claim 1, wherein:
each of said first ratchet teeth has a plurality of abutment surfaces that are parallel to the crankshaft axis, and a plurality of parallel slide surfaces that are inclined relative to said abutment surfaces and that are arranged alternately with said abutment surfaces;
each of said second ratchet teeth has a plurality of abutment faces that are parallel to the crankshaft axis, and a plurality of parallel slide faces that are inclined relative to and arranged alternately with said abutment faces;
said abutment surfaces of said first ratchet teeth abut respectively against said abutment faces of said second ratchet member to co-rotate said driving sprocket with said crankshaft when said crankshaft is rotated in the rotational direction; and
said first ratchet teeth are disengaged from said second ratchet teeth via slide movement of said parallel slide faces of said second ratchet members relative to said slide surfaces of said first ratchet teeth when said driving sprocket is rotated in the rotational direction relative to said crankshaft.

3. The transmission system as claimed in claim 2, wherein:
said first ratchet member further has an outer surrounding surface, an inner surrounding surface surrounded by said outer surrounding surface, a groove-defining surface opposite to said first ratchet teeth along the crankshaft axis, and a retaining groove formed in said groove-defining surface for retaining said opposite end of said resilient element;
said second ratchet member further has an outer surrounding face, an inner surrounding face surrounded by said outer surrounding face, and a plurality of angularly spaced-apart coupling blocks formed on said outer surrounding face; and
said driving sprocket has a plurality of coupling grooves engaged respectively with said coupling blocks.

4. The transmission system as claimed in claim 3, wherein:
said first ratchet member further has a plurality of angularly spaced-apart slide grooves formed in said inner surrounding surface; and
said second section of said crankshaft is formed with a plurality of slide blocks that are respectively engageable with said slide grooves.

5. The transmission system as claimed in claim 1, wherein said transmission unit further includes a bearing sleeved on said first section of said crankshaft, and is interposed between said first section of said crankshaft and said driving sprocket.

6. The transmission system as claimed in claim 1, wherein said drive unit further includes a pair of crank arms mounted respectively at opposite ends of said crankshaft, and a pair of pedals respectively mounted on said crank arms.

7. The transmission system as claimed in claim 1, wherein said hub shell is formed as one piece, is rotatable about an axle axis, and has a sprocket-mounting portion, a first spoke-mounting portion, a tubular portion, and a second spoke-mounting portion arranged in sequential order along the axle axis, said driven sprocket being mounted on said sprocket-mounting portion.

8. transmission system as claimed in claim 7, wherein said hub unit further includes an axle adapted to be mounted to the seat stays of the bicycle and extending along the axle axis, a first bearing sleeved on said axle at a position adjacent to said second spoke-mounting portion of said hub shell, and a second bearing sleeved on said axle at a position adjacent to said sprocket-mounting portion of said hub shell.

9. transmission system as claimed in claim 8, wherein said first bearing is a ball bearing, said second bearing is a double row self-aligning ball bearing.
